(19) United States
(12) Patent Application Publication
(10) Pub. No.: US 2019/0095744 A1
(43) Pub. Date: Mar. 28, 2019

(54) METHOD FOR MAKING A DESCRIPTION OF A PIECE OF LUGGAGE AND LUGGAGE DESCRIPTION SYSTEM

(71) Applicant: SIEMENS AKTIENGESELLSCHAFT, München (DE)

(72) Inventors: GERHARD HAGER, MOEHRENDORF (DE); JUERGEN HOHLWEGLER, ALLENSBACH (DE); BENGT MUECK, DETMOLD (DE); ILIAN PASHOV, KONSTANZ (DE); JOERG ROTTLAND, RADOLFZELL (DE)

(21) Appl. No.: 16/082,133

(22) PCT Filed: Nov. 17, 2016
(86) PCT No.: PCT/EP2016/078044

§ 371 Date: Sep. 4, 2018

(30) Foreign Application Priority Data
Mar. 2, 2016 (EP) 16158164.0

(51) Int. Cl. G06K 9/46; G06Q 10/08; G06K 9/62

(52) U.S. Cl. CPC G06K 9/46; G06N 20/00; G06K 9/6201; G06Q 10/0838

(57) ABSTRACT

A method makes a description of a piece of luggage. In order to detect a plurality of features of a piece of luggage, the piece of luggage is detected by a visual detection device, by which an image of the piece of luggage is produced. The visual features of the piece of luggage can be extracted from the image of the piece of luggage, and a description of the piece of luggage can be generated from the extracted visual features of the piece of luggage.

The invention relates to a method for making a description of a piece of luggage.

In air travel a piece of luggage checked in is usually provided with a luggage label, to enable the piece of luggage to be sorted during the course of transport or to be able to assign information (e.g. transport and/or owner information) to it. Usually during the course of transport the barcode is read out to enable the sorting/assignment to be undertaken. The luggage number, for which in its turn the flight number and further transport information is stored, is encoded with the barcode.

Often a luggage label is damaged during transport of the piece of luggage (for example during transport via luggage belts or conveyor belts, during loading onto the aircraft and/or during unloading from the aircraft). The result can even be that a luggage label for a piece of luggage gets lost. In these cases an assignment of the piece of luggage is very complicated, takes time and a greater human resources effort is involved. In particular when a luggage label gets lost, an attempt must be made manually to obtain information about the owner, e.g. from nametags on the piece of luggage.

An object of the present invention is to specify a method with which a number of features of the piece of luggage can be detected, so that an assignment of a piece of luggage can be designed efficiently.

This object is achieved in accordance with the invention by a method for making a description of a piece of luggage, in which the piece of luggage is detected by means of at least one visual detection device, if necessary also by a number of detection devices, by means of which at least one image of the piece of luggage, or in the case of a number of detection units, a number of images of the piece of luggage, are created, wherein visual features of the piece of luggage are extracted from the at least one image of the piece of luggage or the number of pieces of luggage and a description of the piece of luggage is made from the extracted visual features of the piece of luggage.

The invention is based on the idea that the detection of the piece of luggage and the making of the description of the piece of luggage represents an efficient option, in particular a rapid and labor-saving option, for describing the piece of luggage. Furthermore this method provides the option of being able to assign and/or sort the piece of luggage efficiently, in particular in a rapid and labor-saving manner.

In particular the piece of luggage is visually detected by means of the—at least one—visual detection device. The piece of luggage can be a suitcase, a travel bag, a piece of bulky luggage, a piece of sports equipment or any other piece of luggage.

Preferably the—at least one—image of the piece of luggage comprises at least one part section of the piece of luggage. The image of the piece of luggage can be created in the form of a pixel image, a raster image and/or the like. The image of the piece of luggage can further be a 2D image, 3D image and/or a transformed image.

“Extraction” of visual features of the piece of luggage from the image of the piece of luggage can be understood as the visual features being obtained from the image of the piece of luggage.

For example visual features of the piece of luggage can be obtained from an evaluation and/or an analysis of the at least one image of the piece of luggage or from the number of images of the piece of luggage.

Thus for example a dimension (or size) of the piece of luggage can be established in an expedient manner through a combination of a number of images of the piece of luggage from a number of visual detection units, for example a number of cameras.

It is especially expedient here for an exact position of each of the number of visual detection devices or of each camera to be known. I.e. “fixed-location” detection devices, for example fixed-location cameras, are involved.

Additional information, such as about a focal length of a lens of the visual detection device and pixel spacings of sensors is also expedient here, i.e. for extraction of visual features or of the dimension, a dimension or size of an object/piece of luggage being able to be “estimated” therefrom—in a similar way as with a stereo camera.

Where the number of images of a piece of luggage only show part sections of the piece of luggage, a speed of transport of the piece of luggage and image recording frequencies of the number of visual detection units or cameras is further expedient information that can be included for determination for extraction of visual features or of the dimension.

For at least one image of a piece of luggage from the at least one visual detection device, for example from an individual hand-held camera, the determination of the dimension or of the size of the piece of luggage can be estimated from dimensions or sizes of known objects in at least one piece of luggage, e.g. a luggage label is appr. 50 mm wide—and this makes it possible to deduce the dimension or the size of the piece of luggage.

The description of the piece of luggage can further be made by the extracted visual features of the piece of luggage being combined. The description of the piece of luggage can take any given form, e.g. the description of the piece of luggage can be made in the form of a vector or in the form of a descriptive text.

Expediently the image of the piece of luggage is detected automatically by means of the visual detection device. In particular the visual detection can be undertaken at least semi-automatically. In this case the visual detection device itself focuses on the piece of luggage and/or initiates the detection itself. With a semi-automatic detection a part step of the detection can be carried out in another way than by the detection device itself, for example by a person handling the luggage.

In an advantageous embodiment of the invention the visual detection device is a hand-held detection device, in particular a hand-held camera and/or a hand-held scanner. The visual detection device can also be a hand-held laser camera and/or a hand-held laser scanner. In the case in which the visual detection device is a hand-held detection device, a substep of the detection, e.g. the positioning of the hand-held detection device, is sensibly carried out by the person handling the luggage.

The image of the piece of luggage can further be detected fully automatically by the visual detection device, in particular without the manual intervention of a person. For example the visual detection device can be a fully automatic camera or a fully automatic scanner.

The image of the piece of luggage can further be created automatically, in particular by means of a data processing unit. The visual features of the piece of luggage can also be extracted automatically from the image of the piece of luggage, in particular by means of a data processing unit. Moreover the description of the piece of luggage can be made automatically from the extracted features of the piece of luggage, in particular by means of the data processing unit.

Expediently the data processing unit is configured to extract the visual features of the piece of luggage from the image of the piece of luggage and/or to make the description of the piece of luggage from the extracted visual features of the piece of luggage, for example through a corresponding executable computer program which runs on the data processing unit.

The invention and/or the described developments can—at least in part—be realized both in software and also in hardware, for example by using a specific electrical circuit.

The realization of the invention and/or of the described developments is further possible—at least in part—by a computer-readable storage medium on which the computer program is stored, which executes the invention or developments—at least in part.

The invention and/or the described developments can also be realized—at least in part—by a computer program product, which has a storage medium on which the computer program is stored, which executes the invention or developments—at least in part.

The visual features of the piece of luggage can comprise a dimension of the piece of luggage, a shape of the piece of luggage, a color of the piece of luggage, a patterning of the piece of luggage, a logo of the piece of luggage and/or a brand name of the piece of luggage. The dimension of the piece of luggage can comprise a length of the piece of luggage, a width of the piece of luggage and/or a height of the piece of luggage. The logo of the piece of luggage can also comprise an emblem of a manufacturer of the piece of luggage, a visual design mark of the manufacturer of the piece of luggage and/or a design element of the manufacturer of the piece of luggage.

Expediently the description of the piece of luggage is made in the form of a description vector. The description vector can further be one-dimensional or multi-dimensional. Preferably the description vector comprises a number of vector fields. Moreover each vector field can comprise a visual feature, in particular in the form of text and/or digits.

The description of the piece of luggage can further be made in the form of a descriptive text.

An additional element can be arranged on the piece of luggage. The additional element can be an identification element for example. The additional element can further be a luggage label for example, also called a baggage label or banderole, an adhesive label and/or a hanging label. The hanging label can be a hanging label of an airline, a hanging label of an airport or a personal hanging label for example. Preferably the additional element is connected releasably to the piece of luggage. Moreover the additional element can be able to be removed from the piece of luggage.

In a preferred embodiment of the invention the additional element arranged on the piece of luggage is detected by means of the visual detection device. Expediently an additional image is created by means of the detection device. Visual features of the additional element can be extracted from the additional image. An additional description can also be made from the extracted visual features of the additional element. Expediently the additional description, together with the description of the piece of luggage, forms an extended description of the piece of luggage. In this way an extended description of the piece of luggage is made from the extracted visual features of the additional element and also from the extracted visual features of the piece of luggage.

The image of the piece of luggage and the additional image can each be a part area of common image. As an alternative the image of the piece of luggage and the additional image can each be at least one part area in different images for example.

The visual features of the additional element can comprise a shape of the additional element, a color of the additional element, a patterning of the additional element, a dimension of the additional element and/or a logo of the additional element. The dimension of the additional element can comprise a length of the additional element, a width of the additional element and/or a height of the additional element. The logo of the additional element can further comprise an emblem, a visual design mark and/or a design element.

The piece of luggage can have an additional element with a set of information of the form of clear text. The additional element can be the additional element mentioned above. Preferably in the visual detection the set of information will be at least partly visually detected. At least a part of the set of information can further be recognized by means of optical text recognition, in particular OCR (Optical Character Recognition).

The recognized part of the set of information can be stored as a description of the set of information for example. The recognized part of the set of information can further be stored (e.g. as a description of the set of information) in the expanded description of the piece of luggage and/or in addition to the expanded description of the piece of luggage.

Preferably the set of information comprises additional information, such as e.g. transport and/or owner information. For example the set of information can comprise a luggage number, an owner name, also referred to as a passenger name, a flight number, a transit airport abbreviation and/or a destination airport abbreviation, in particular as transport and/or owner information. The set of information can further comprise processing information. In particular processing information can be processing instructions, such as e.g. “short connection time”, “handle with priority”, and/or “handle with care FRAGILE”. Processing information can further comprise safety information.

Expediently the piece of luggage is sorted automatically using the recognized part of the set of information. In this way the recognized part of the set of information is taken into account automatically during the sorting.

Sort luggage can be expressed as assign luggage. In particular a piece of luggage can be assigned transport, owner and/or processing information during sorting. Sort luggage can also contain one or more transport step(s) of the piece of luggage in accordance with the assignment for example.

Preferably the sorting is done in an airport. In that a part of the set of information is recognized, the piece of luggage can be assigned for example to a destination location to which the piece of luggage is to be transported. In this case the destination location can be a specific gate, a specific loading zone, a specific aircraft, a specific means of luggage transport (in particular a specific luggage belt), a destination airport, a luggage claim belt at a destination airport or the like for example.

In that a part of the set of information is recognized, the piece of luggage can take a specific sorting route for example. For example the piece of luggage can take a sorting route in which the piece of luggage is transported more quickly to a destination location and/or in which the piece of luggage is essentially not subjected to any shocks.

Advantageously visual features, in particular visual features of the piece of luggage and/or visual features of the additional element, are extracted using prior knowledge and/or using trainable systems.

For example the data processing unit can learn typical layouts, i.e. typical features, of additional elements, in particular of luggage labels and/or have them stored as prior knowledge. In this way deductions can be made from recognized and/or extracted visual features of the additional element about further information, such as transport and/or processing information. For example a specific airline can be deduced from specific visual features of the additional element. In this way a sorting/assignment is made possible and/or improved.

Expediently the description of a piece of luggage (or expanded description of a piece of luggage) made during a visual detection of the piece of luggage can be stored as a comparative description. For example the comparative description can be stored during a handover of the piece of luggage and/or a check-in. Preferably the comparative description will be stored in a database. In particular the comparative description can be stored in a data record. The data record—as well as the comparative description—can have further information, such as transport, owner and/or processing information. In particular the data record—as well as the comparative description—can comprise a luggage number, an owner name, a flight number, a transit airport abbreviation or name, a destination airport or name and/or a destination location as further information.

There is the further option of keeping the comparative description anonymous or anonymize it, which then expediently does not comprise any owner information, in particular no owner name.

Advantageously the comparative description or the data record is stored automatically. The comparative description or the data record can further be stored for a limited time.

The description of the piece of luggage (or the expanded description of the piece of luggage), can further be made available, in particular as a comparative description, in particular for given locations (“where”) at given times (“when”) for given persons {“for whom”) and for given purposes (“for what”).

The piece of luggage can be a piece of flight luggage. Preferably the comparative description will be made available to further or also to all airports involved in the transport of the piece of luggage. The airports involved in the transport of the piece of luggage can for example be a departure airport, a transit airport and/or a destination airport of the piece of luggage. In particular the data record in which the comparative description is stored will be made available to all airports involved in the transport of the piece of luggage. In this way all airports involved in the transport of the piece of luggage can have access to the comparative description or to the data record. For example the comparative description can be transferred to all airports involved in the transport of the piece of luggage. For example the comparative description or the data record can be stored locally in a respective database of the respective airport. The comparative description or the data record can further be stored in a distributed database, to which the airports involved have access.

Since the description of the piece of luggage is made from the extracted visual features of the piece of luggage, the description of the piece of luggage is expediently specific for the piece of luggage.

In a preferred embodiment of the invention the method is employed during checking. Advantageously a check is made in the checking as to whether the description of the piece of luggage (or the expanded description of the piece of luggage) matches a comparative description. The comparative description can be the comparative description already mentioned. The comparative description can further be another comparative description stored in a database.

Expediently the check will be carried out at a later point in time than the time at which the comparative description was stored. The comparative description can be stored during a first detection of the piece of luggage by means of the visual detection device. In particular a first image of the piece of luggage can be created during a first detection of the piece of luggage. A first description of the piece of luggage can further be made from the first image of the piece of luggage. The first description of the piece of luggage can be stored as a comparative description.

Expediently the check is made during or at a time after a second detection of the piece of luggage, wherein the second detection takes place at a time after the first detection. One or more transport and/or sorting steps can further lie between the first detection and the second detection. In particular a second image of the piece of luggage can be created during the second detection of the piece or luggage. A second description of the piece of luggage can further be created from the second image of the piece of luggage. During the checking a check can be made in particular as to whether the second description of the piece of luggage matches the comparative description. This means that the description of the piece of luggage checked during the second check can be a second description of the piece of luggage, which in particular has the same characteristics and features as the first-mentioned or first description of the piece of luggage.

Expediently the check is made automatically, in particular by means of the data processing unit.

The database can comprise a number of comparative descriptions. Preferably the number of comparative descriptions comprises the above-mentioned comparative description. Each of the number of comparative descriptions can be stored in a data record. Expediently the number of comparative descriptions will be compared (at least partly) one after another with the description of the piece of luggage (or with the expanded description of the piece of luggage).

The method can be employed during further checking. A check is preferably made during the further checking as to which of the comparative descriptions of the database has the closest match with the description of the piece of luggage (or with the expanded description of the piece of luggage). The description of the piece of luggage to be checked/being checked during the further checking can also be the second description of the piece of luggage or the second expanded description of the piece of luggage. Expediently the further check is made automatically, in particular by means of the data processing unit.

For checking the closest match (in the further check) the descriptions of the piece of luggage can be checked one after another for example with each of the comparative descriptions stored in the database. A degree of matching can be determined for each comparison for example. That comparative description for which the highest degree of matching is achieved can be selected. The information of the data record in which the selected comparative description is stored can further be used, in particular to enable the piece of luggage to be sorted/assigned.

Preferably the method is employed to identify a piece of luggage. The piece of luggage can be identified for example by a unique assignment of the piece of luggage to a data record. In particular at least one of the aforementioned checks can lead to an identification of the piece of luggage.

The identification can take place during the transport process, in particular in order to establish a destination location of the piece of luggage. The identification can further take place for found pieces of luggage, in particular in order to establish the owner of a found piece of luggage.

An advantage of the identification of the piece of luggage is that the description of the piece of luggage can be used in order to obtain information about the piece of luggage. The processing of a piece of luggage is then possible without a barcode, a luggage number and/or a luggage label.

Expediently the method will be employed for an assignment. The description of the piece of luggage can be used to assign information, in particular transport, owner and/or processing information, to a piece of luggage.

The information can be assigned directly from the description of the piece of luggage in such cases. If there is a specific dimension of the piece of luggage in the description of the piece of luggage for example, which allows it to be deduced that this is a bulky piece of luggage, the piece of luggage can be given special treatment for example, in particular conveyed via a specific sorting route.

The information can further be assigned via the identification of the piece of luggage. In this case a data record, from which the information can be read out, can be uniquely assigned to the piece of luggage. In this way the piece of luggage can be assigned a luggage number, a flight number, a destination location and/or an owner name. For example the method can be used to establish an owner of a found piece of luggage.

The method can further be employed to create an image of the piece of luggage. In the creation of the image an image of the piece of luggage can be created from the description of the piece of luggage. In particular the image of the piece of luggage is a picture of the piece of luggage, a schematic diagram of the piece of luggage, a 2D model of the piece of luggage and/or a 3D model of the piece of luggage. The image can be created by means of the data processing unit.

The method can further be employed to find a missing piece of luggage. In particular the method can be employed to find a missing piece of luggage by an image of the piece of luggage being created from the description of the piece of luggage.

For example a missing piece of luggage of an owner can be found. To this end a search is conducted in the database for example for the owner name and/or for the luggage number and the data record for the missing piece of luggage is found. From the data record for the missing piece of luggage, in particular from the comparative description of the missing piece of luggage, which is preferably stored in the data record for the missing piece of luggage, an image of the missing piece of luggage can be created. The collection point at which the missing piece of luggage is located can further be stored in the data record for the missing piece of luggage, With the aid of the created image of the missing piece of luggage a search can be conducted at the collection point for the missing piece of luggage, in particular for all pieces of luggage located at the collection point can be compared with the image of the missing piece of luggage. In this way the missing piece of luggage can be found.

The method for finding a missing piece of luggage can further be employed by the data record for the missing piece of luggage and/or the comparative description for the missing piece of luggage being reconciled with other data records. The other data records can be stored in the same database and/or can be stored in another database, e.g. of another airport.

The image of the piece of luggage created from the description of the piece of luggage can be compared with a comparison image. The comparison can be made automatically, in particular by means of the data processing unit, and/or manually. The comparison image can be created from a comparative description, in particular by means of the data processing unit. In particular the comparative description can be the aforementioned comparative description.

Moreover the method can be employed in checking a piece of luggage. Expediently a check is made during the checking of a piece of luggage as to whether an appearance of the piece of luggage has changed, in particular whether the piece of luggage has been damaged (e.g. during transport and/or during sorting). If the result of the checking of the piece of luggage is that the piece of luggage has changed, in particular that the piece of luggage has been damaged, a further check can be made during the checking of the piece of luggage as to the extent to which the appearance of the piece of luggage has changed. The piece of luggage can be checked automatically, in particular by means of the data processing unit, and/or manually.

For example the check on the piece of luggage can be made using the created image. In particular a check can be made during the checking of the piece of luggage as to whether the image created from the description of the piece of luggage differs from the comparison image. A further check can be made during the checking of the piece of luggage as to the extent to which the image created from the description of the piece of luggage differs from the comparison image, i.e. what differences exist between the image created from the description of the piece of luggage and the comparison image.

The piece of luggage can further be checked using the description of the piece of luggage. In particular a check can be made during the checking of the piece of luggage as to whether the description of the piece of luggage differs from the comparative description. A further check can be made during the checking of the piece of luggage as to the extent to which the description of the piece of luggage differs from the comparative description, i.e. what differences exist between the description of the piece of luggage and the comparative description. In particular the description of the piece of luggage checked in the checking of the piece of luggage can be the second description of the piece of luggage.

If the result of the checking of the piece of luggage is that the piece of luggage has changed, in particular that the piece of luggage has been damaged, a further check can be made during the checking of the piece of luggage as to the transport steps in which the change/damage has occurred. Expediently for this purpose the piece of luggage is detected a number of times in the course of its transport at different luggage description systems in the way previously described. Expediently a luggage description is created during each of the detections. Each of the created descriptions of the piece of luggage is preferably stored together with a code number of the luggage description system for example, in particular in the database. For example a data record for the piece of luggage can comprise a number of descriptions of this piece of luggage and if necessary the associated code numbers of the respective luggage description system.

In an advantageous embodiment of the invention the method is employed for a plurality of pieces of luggage, wherein a description of the piece of luggage is preferably created for each of the pieces of luggage.

The method can further be employed for statistical evaluation of visual features of pieces of luggage, in particular when the method is employed for a plurality of pieces of luggage. Expediently, in the statistical evaluation of visual features at least a part of the detected visual features of the pieces of luggage is statistically evaluated.

For example the statistical evaluation of the dimensions of the piece of luggage (for a plurality of pieces of luggage) can be used for transport optimization, in particular for an optimization of the loading of a transport truck and/or of an aircraft. The statistical evaluation of the shape, color and or brand of the piece of luggage can further be used for example for a product design and/or for advertising purposes.

The statistical evaluation can be undertaken for example in accordance with specific criteria, such as e.g. in accordance with a departure airport, in accordance with a destination country, in accordance with a gender of the owner and/or the like. For example the statistical evaluation can be carried out separately for a number of seasons, e.g. for summer and winter. In this way a check can be made as to whether some of the detected features, e.g. a color of the piece of luggage, differ for different seasons.

The invention further relates to a luggage description system, which in accordance with the invention comprises a visual detection device and a data processing unit for carrying out the aforementioned method. In particular the invention relates to a luggage description system with a visual detection device for visual detection of the piece of luggage as an image of a piece of luggage and a data processing unit for extraction of visual features of the piece of luggage from the image of the piece of luggage and also for making a description of the piece of luggage from the extracted visual features of the piece of luggage.

The luggage description system can be employed for carrying out the method described above. Consequently the elements of the luggage description system can be the elements previously mentioned in conjunction with the method.

The description of advantageous embodiments of the invention given above contains numerous features, which can in some cases be reproduced in the individual subclaims combined in multiples. These features can however expediently also be considered individually and are able to be combined into sensible further combinations. In particular these features are each able to be combined individually and in any suitable combination with the inventive inventive method and the luggage description system. Thus method features are also to be seen formulated physically as a characteristic of the corresponding luggage sorting system and vice versa.

Even if a few terms are used in the description or in the claims in the singular or in conjunction with a numeral, the scope of the invention should not be restricted for these terms to the singular or to the respective numeral.

The characteristics, features and advantages of this invention described above, as well as the manner in which these are achieved, will become clearer and easier to understand in conjunction with the following description of the exemplary embodiment, which will be explained in greater detail in conjunction with the drawings. The exemplary embodiment serves to explain the invention and does not restrict the invention to the combination of features specified therein, not even in relation to functional features. Moreover suitable features of the exemplary embodiment can also be considered for this purpose explicitly in isolation, removed from the exemplary embodiment and/or combined with any given one of the claims.

In the figures:

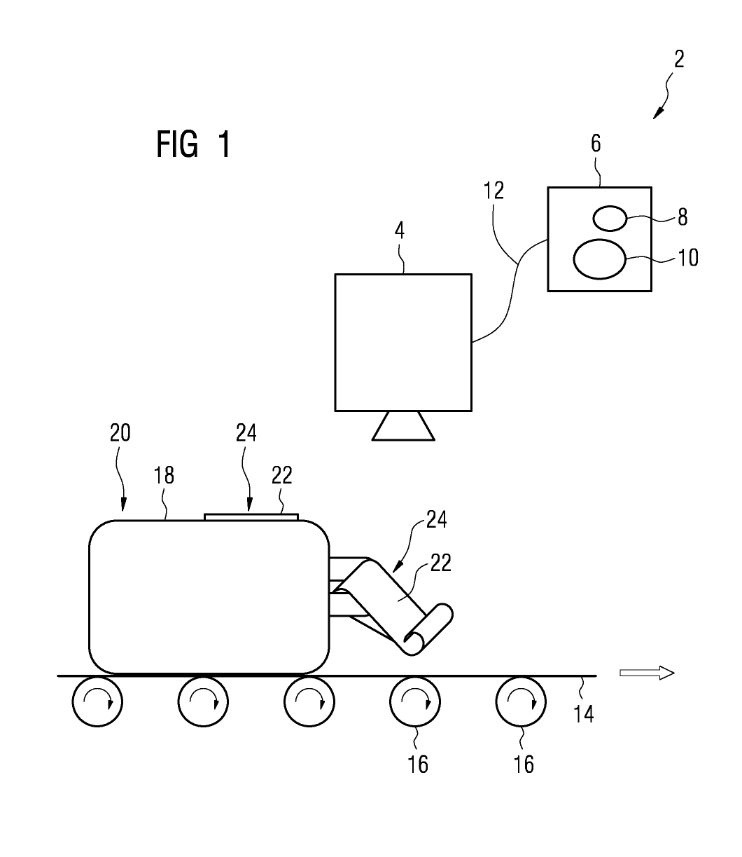

FIG. 1 shows a luggage description system with a visual detection device and a data processing unit;

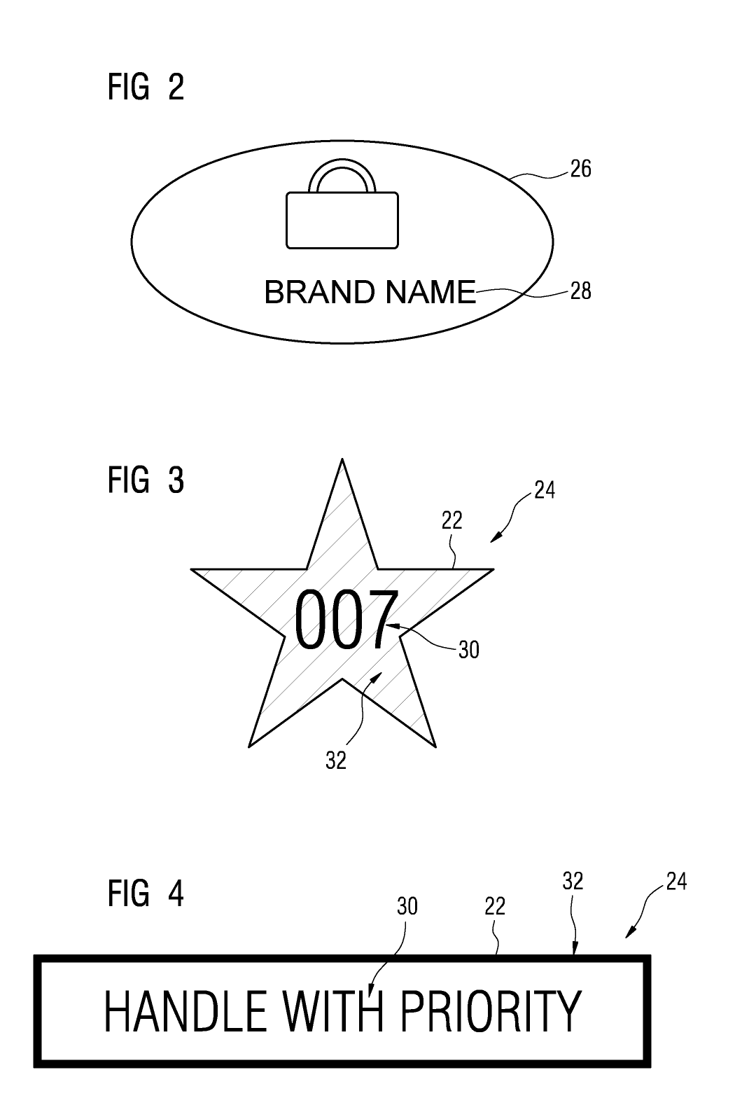

FIG. 2 shows a logo for a piece of luggage and a brand name of a piece of luggage;

FIG. 3 shows a first additional element of the piece of luggage;

FIG. 4 shows a second additional element of the piece of luggage;

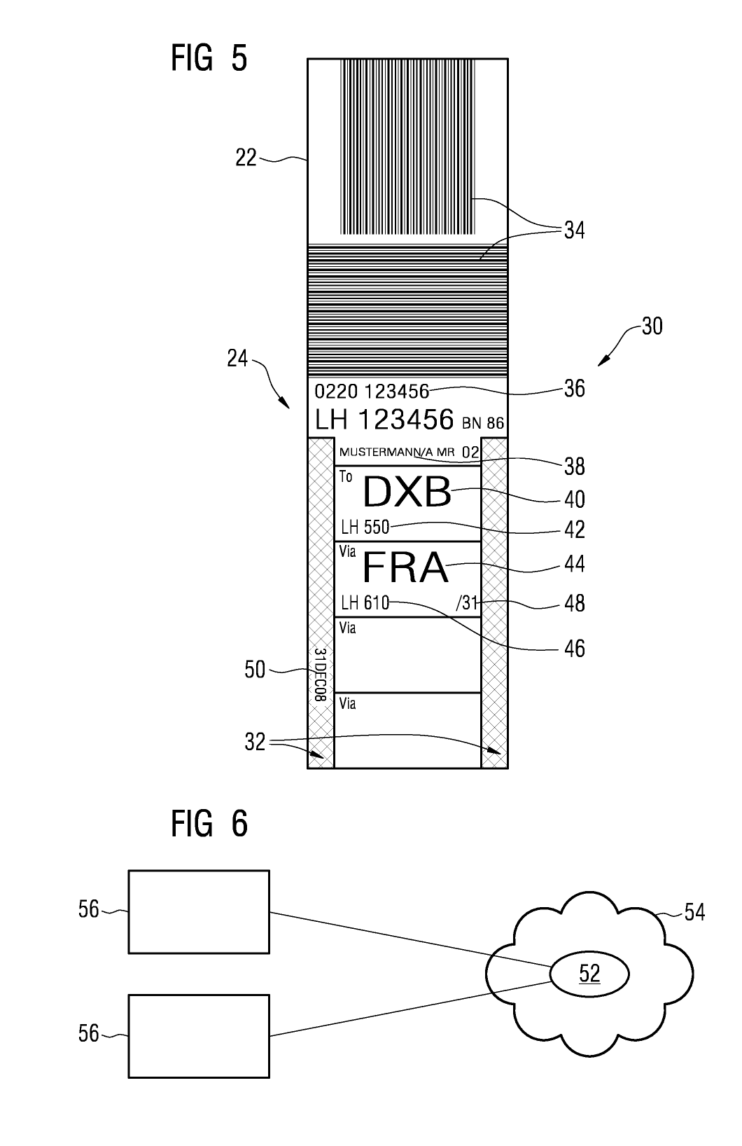

FIG. 5 shows a third additional element of the piece of luggage; and

FIG. 6 shows a database, which is stored in a Cloud.

FIG. 1 shows a schematic of a luggage description system 2 with a visual detection device 4 and a data processing unit 6. The visual detection device 4 is embodied as a camera. The data processing unit 6 further comprises a database 8 and also a computer program 10. The computer program 10 runs on the data processing unit 6.

The visual detection device 4 and the data processing unit 6 are connected to one another by a data transfer connection 12. The data transfer connection 12 can be a cable for example. The data transfer connection 12 can also be a wireless connection for example.

Also shown in FIG. 1 is a luggage belt 14, which runs over rollers 16. The directions of movement of the rollers 16 and of the luggage belt 14 are represented by arrows. Located on the luggage belt 14 is a piece of luggage 18, in particular a piece of flight luggage. In principle the piece of luggage 18 can also be transported via luggage trays and/or by another means of luggage transport.

The piece of luggage 18 has a number of visual features 20 of the piece of luggage 18. Attached to the piece of luggage 18 is an additional element 22, wherein the additional element 22 is connected releasably to the piece of luggage 18. The additional element 22 too has a number of visual features 24 of the additional element 22.

The piece of luggage 18 is detected by means of the visual detection device 4. An image of the piece of luggage 18 is also created by the visual detection device 4. The image of the piece of luggage comprises an upper side of the piece of luggage 18 and is present in the form of a pixel image. Moreover visual features 20 of the piece of luggage 18 are extracted from the piece of luggage 18, in particular by means of the data processing unit 6.

In this example the extracted visual features of the piece of luggage 18 are a dimension of the piece of luggage, in particular a length and a width of the piece of luggage, a shape of the piece of luggage, a color of the piece of luggage, a patterning of the piece of luggage, a logo 26 of the piece of luggage and a brand name 28 of the piece of luggage.

A description of the piece of luggage is further made from the extracted visual features of the piece of luggage 18, in particular in the form of a description vector. The description vector comprises a number of vector fields, wherein each vector field comprises a visual feature 20 of the piece of luggage 18.

All steps (visual detection, creation of the image of the piece of luggage, extraction of the visual features 18 and creation of the description of the piece of luggage) are undertaken fully automatically in this exemplary embodiment, i.e. without the manual intervention of a person.

In principle it would also be possible for the visual detection device by be a hand-held camera, so that the visual detection would take place semi-automatically.

In principle the form of the description of the piece of luggage can be as follows:

(length of the piece of luggage, width of the piece of luggage, shape of the piece of luggage, color of the piece of luggage, patterning of the piece of luggage, logo 26 of the piece of luggage and brand name 28 of the piece of luggage).

In particular the description of the piece of luggage can be as follows:

{60 cm, 40 cm, rectangular, RGB 139/69/19, 0, L 221, Koffermacher].

The description of the piece of luggage comprises numbers and letters. The visual features 20 of the piece of luggage 18 can be written out in full, abbreviated and/or encoded. The absence of a visual feature can also be understood as a visual feature. E.g. if the piece of luggage 18 is missing a patterning of the piece of luggage—i.e. the piece of luggage 18 is not patterned (visual feature 20: “no luggage patterning”) and a zero is entered into the corresponding “luggage patterning” vector field.

The additional element 22 arranged on the piece of luggage 18 is likewise detected by means of the visual detection device 4, by means of which an additional image is created. From the additional image visual features 24 of the additional element 22 are extracted and from the extracted visual features 24 of the additional element 22 an additional description is made, in particular in each case by means of the data processing unit 6. The additional description is also present in the form of a vector. Together with the description of the piece of luggage, the additional description further forms an expanded description of the piece of luggage.

The additional element 22 can be the additional element 22 shown in FIG. 3, in FIG. 4 or in FIG. 5 for example.

The additional element 22 comprises a set of information 30 in the form of clear text 30 (see FIGS. 3-5). During the visual detection the set of information 30 will be detected at least partly visually and at least a part of the set of information 30 will be recognized by means of text recognition, in particular by means of OCR (Optical Character Recognition). The recognized part of the set of information 30 can be stored partly in the additional description and/or in a description at least of the set of information (cf. FIGS. 3-5). The description of the set of information is present in the form of a vector.

The visual features 20, 24 are extracted using prior knowledge and using trainable systems.

The prior knowledge is stored in the data processing unit 6. For example various luggage logo templates and luggage brand name templates are stored as prior knowledge. The stored luggage logo templates are further assigned code numbers for example. If an extracted logo for a piece of luggage essentially corresponds to a luggage logo template, then the extracted logo for a piece of luggage is encoded in the description of the piece of luggage with the corresponding code number of the corresponding luggage logo template (see also FIG. 2).

The data processing unit 6, in particular a computer program 10 of the data processing unit 6, is a trainable system. For example a logo for a piece of luggage is also assigned to a luggage logo template if the logo for a piece of luggage is altered to a predetermined extent, e.g. if the logo for a piece of luggage has a scratch, if the logo for a piece of luggage is dirty, if a color of the logo for a piece of luggage is altered to a predetermined extent and/or the like.

Specific visual features 24 of additional elements 22 can further be stored as prior knowledge. This is described in more detail in FIGS. 4 and 5.

The description of the piece of luggage or expanded description of the piece of luggage made during the visual detection of the piece of luggage 18 is stored as a comparative description, in particular in the database 8. The database 8 comprises a data record, which in its turn comprises the comparative description. Moreover the database comprises further information and/or the description of the set of information. In particular the data record comprises a luggage number, an owner number, a flight number, a destination airport and so forth.

The comparative description is further made available at given locations (“where”) at given times (“when”) for given people (“for whom”) and for given purposes (“for what”). In particular the comparative description is made available to further or also to all airports involved in the transport of the piece of luggage 18. In this case the data record in which the comparative description is stored is made available to further or also to all airports involved in the transport of the piece of luggage 18. In this example the data record or the comparative description is transferred to all airports involved in the transport of the piece of luggage 18 and the data record or the comparative description is stored locally in the database 8 of the airport.

The visual detection (by means of the visual detection device 4) for storing the comparative description is a first visual detection in this case. A first description of the piece of luggage is further stored as a comparative description.

During the course of the transport of the piece of luggage 18, the piece of luggage 18 comes to an identical second luggage description system 2. There the piece of luggage 18 is detected a second time, which delivers a second description of the piece of luggage (or a second expanded description of the piece of luggage). The second description of the piece of luggage or the second expanded description of the piece of luggage will be referred to below only as the second description of the piece of luggage.

A further check is made during checking as to whether the second description of the piece of luggage matches a comparative description, which in particular is stored in the database 8. The comparative description can be the comparative description previously mentioned or can be another comparative description stored in the database 8. The check is carried out automatically by means of the data processing unit 6, in particular by means of the computer program 10. Expediently the database 8 comprises a number of comparative descriptions, including the first-mentioned comparative description, e.g. the second description of the piece of luggage can be compared in turn with each of the number of comparative descriptions.

In this example the second description of the piece of luggage does not match any of the number of comparative descriptions, e.g. because the piece of luggage has been damaged during transport.

Moreover a check is made during further checking as to which of the comparative descriptions of the database 8 has the closest match to the second description of the piece of luggage. That comparative description which most closely matches the second description of the piece of luggage is assigned to the piece of luggage 18. A comparison of the second description of the piece of luggage with that comparative description which most closely matches the second description of the piece of luggage enables a check to be made as to whether and to what extent the appearance of the piece of luggage 18 has changed, in particular whether and to what extent the piece of luggage 18 has been damaged.

Moreover that data record that comprises that comparative description which most closely matches the second description of the piece of luggage is assigned to the piece of luggage 18. The method is used in this way for identifying the piece of luggage 18. Further information is then read out from the data record, which was assigned to the second description of the piece of luggage—i.e. the information is assigned to the second description of the piece of luggage and thus to the piece of luggage 18.

The identification can take place during the transport process for example, in particular in order to establish a destination location of the piece of luggage 18. The piece of luggage 18 can further be a found piece of luggage 18—i.e. the identification can take place for a found piece of luggage 18, in particular to establish the owner of a found piece of luggage 18.

In this way the method is used for an assignment, wherein the second description of the piece of luggage is used to assign information—in particular from the data record that comprises the matching comparative description.

For example the piece of luggage 18 is assigned transport, owner and/or processing information, in particular a luggage number, a flight number, a destination location and/or an owner name. The method can be used for example to establish an owner of a found piece of luggage 18.

The piece of luggage 18 can further be assigned information directly from the second description of the piece of luggage. If the second description of the piece of luggage is the expanded second description of the piece of luggage then visual features 24 of the additional element 22 are also found in the second description of the piece of luggage. For example processing information can be marked on the additional element 22, such as e.g. on the additional element 22 from FIG. 4. As a result of the detected and extracted visual features 24 of the additional element 22 and/or the recognized parts of the set of information 30, the piece of luggage 18 will be given special treatment, in particular the piece of luggage 18 will be conveyed via a specific sorting route.

In principle it is possible for the piece of luggage 18 to have a number of additional elements 22, e.g. two of the additional elements shown in FIGS. 3-5 or all of the additional elements 22 shown in FIGS. 3-5.

The method is further employed for creating an image of the piece of luggage 18, wherein an image of the piece of luggage 18 is created from the second description of the piece of luggage, in particular by means of the data processing unit 6. The image of the piece of luggage 18 is a 2D model of the piece of luggage 18 for example.

The image of the piece of luggage 18 is compared with a comparison image, with said comparison image being created from the comparative description. A luggage check is also carried out, in which the image of the piece of luggage 18 is compared with the comparison image, in order to check whether and the extent to which the appearance of the piece of luggage 18 has altered, in particular whether and to what extent the piece of luggage has been damaged (e.g. during transport and or during sorting).

In principle an image of the piece of luggage 18 can also be created during the method for image creation from the first description of the piece of luggage. In particular a missing piece of luggage 18 can be found in this way. For example the missing piece of luggage 18 of an owner can be found. Then for example a search is made in the database 8 for the owner name and/or for the luggage number and the data record for the missing piece of luggage 18 found. An image of the missing piece of luggage 18 can be created from the data record for the missing piece of luggage 18, in particular from the comparative description for the missing piece of luggage 18, which is preferably stored in the data record for the missing piece of luggage 18. The collection point at which the missing piece of luggage 18 is located can further be stored in the data record for the missing piece of luggage 18, in particular by all missing pieces of luggage located at the collection point being compared manually with the image of the missing piece of luggage 18. In this way the missing piece of luggage 18 can be found.

A missing piece of luggage 18 can further be found by the data record for the missing piece of luggage 18 and/or the comparative description for the missing piece of luggage 18 being reconciled with other data records. The other data records can be stored in another database, e.g. of another airport.

The image of the piece of luggage 18 created from the description of the piece of luggage can be compared with a comparison image. The comparison image can be created from a comparative description. In particular the comparative description can be the previously mentioned comparative description.

The method shown is used for a plurality of pieces of luggage 18, wherein each piece of luggage 18 has visual features 20. Moreover each piece of luggage 18 can have one or more additional elements 22. Some of the detected visual features 20 of the pieces of luggage 18 will also be statistically evaluated. For example the luggage dimension can be statistically evaluated in order to optimize the loading of transport trucks and/or of aircraft. The color of the piece of luggage can also be statistically evaluated in the summer season, e.g. in order to use the luggage color most used in summer for a product design.

Some of the visual features 24 detected of the additional elements 22 can further be statistically evaluated. For example the frequency of specific processing information can be evaluated, e.g. to determine a loading of a specific sorting route.

By way of example, FIG. 2 shows the luggage logo 26 of the piece of luggage 18 from FIG. 1. The luggage logo 26 is oval, gray in color and contains the symbol of a suitcase and also a brand name 28 “Koffermacher” of the piece of luggage.

Stored as prior knowledge in the data processing unit 6 from FIG. 1 are various logo templates and brand name templates for pieces of luggage. The extracted luggage logo 26 essentially corresponds to a logo for a piece of luggage which is assigned the code number “L 221” and is encoded in the description of the piece of luggage with the corresponding code number.

By way of example, FIG. 3 shows a first possible additional element 22 of the piece of luggage 18 from FIG. 1. The additional element 22 is designed as an adhesive label on the piece of luggage 18. The additional element 22 further comprises a set of information 30 in the form of clear text 30.

The visual detection device 4 from FIG. 1 detects the additional element 22 with the piece of luggage 18 in a common pixel image. I.e. the additional image is a subarea of the pixel image and the image of the piece of luggage is another subarea of the pixel image.

An additional description is made from the additional image detected—as already explained in FIG. 1.

For example the form of the additional description can be as follows:

[length of the additional element 22, width of the additional element 22, shape of the additional element 22, color of the of the additional element 22, patterning 32 of the additional element 22, clear text 30, color of the clear text 30, position of the clear text 30].

In particular the additional description can be as follows:

[8 cm, 8 cm, star-shaped, RGB 255/255/255, thin strips of RGB 0/0/0 with strip spacing 0.8 cm, “007”, RGB 0/0/0, central].

This means that here for example the set of information 30 in the form of clear text 30 will be included as well in the additional description.

By way of example, FIG. 4 shows a second possible additional element 22 of the piece of luggage 18 from FIG. 1. The additional element 22 can be designed as an adhesive label or as a hanging label.

The visual detection device 4 from FIG. 1 detects the additional element 22 with the piece of luggage 18 in a common pixel image.

The additional element 22 has as its patterning 32 a red edge with a line width of 0.5 cm. The additional element 22 further comprises a set of information 30 in the form of clear text 30. The set of information 30 in the form of clear text 30 contains processing information. The clear text 30 is written in red.

For example the form of the additional description can be as follows:

[length of the additional element 22, width of the additional element 22, shape of the additional element 22, color of the of the additional element 22, patterning of the additional element 22, clear text 30, color of the clear text 30, position of the clear text 30].

In particular the additional description can be as follows:

[25 cm, 4 cm, rectangular, white, red edge with a line width of 0.5 cm, yes, red, central].

Stored as prior knowledge in the data processing unit from FIG. 1 are various additional element templates. The visual features “red edge with a line width of 0.6 cm” and ‘Red clear text” are assigned “as prior knowledge” the processing information “give special treatment”. The data processing unit 6 has further already learned that the line width of the edge can vary in the range of ±0.2 cm. Accordingly the data processing system assigns the piece of luggage 18 the processing information “give special treatment” and the piece of luggage 18 is conveyed via a specific sorting route.

At least a part of the set of information 30 in the form of clear text 30 can further be recognized by means of text recognition. For example the part of the set of information 30 detected can be detected in a description of the set of information, which runs as follows [“HANDLE WITH PRIORITY”].

Stored in the data processing unit as prior knowledge is that the text “HANDLE WITH PRIORITY”, regardless of being written in upper case/lower case, means that the piece of luggage 18 is to be conveyed via a specific sorting route.

The set of information 30 detected consequently likewise leads to a corresponding sorting, so that the piece of luggage 18 will be conveyed via the specific sorting route.

By way of example, FIG. 5 shows a third possible additional element 22 of the piece of luggage 18 from FIG. 1. The additional element 22 is designed as a luggage label.

The visual detection device 4 from FIG. 1 detects the additional element 22 and the piece of luggage 18.

For example the form of the additional description can be as follows:

[length of the additional element 22, width of the additional element 22, shape of the additional element 22, color of the of the additional element 22, patterning 32 of the additional element 22, clear text 30, color of the clear text 30, position of the clear text 30].

In particular the additional description can be as follows:

[5 cm, 20 cm, rectangular, white, green stripes with a strip width of 0.5 cm, yes, black, several].

At least a part of the set of information 30 in the form of clear text 30 is further recognized by means of text recognition. Moreover the additional element 22 comprises a barcode 34, which is likewise recognized. The recognized part of the set of information 30 (together with the detected barcode 34) is detected at least partly in a description of the set of information 30, which has the following form for example:

[decoded barcode 34, luggage number 36, owner name 38, destination airport abbreviation 40, flight number 42, transit airport abbreviation 44, flight number 46, flight date 48, date of issue 50].

The recognized set of information is as follows:

[0220 123456, 0220 123456, Mr A Mustermann, DXB, LH 550, flight number FRA, LH 610, 31, 31DEC08].

Stored as prior knowledge in the data processing unit 6 from FIG. 1 are various additional element templates. The visual feature “green stripes” “with a stripe width of 0.5 cm” is assigned as prior knowledge “piece of luggage was checked-in in the Schengen area” and the airline is Lufthansa. The data processing unit 6 has already learned that the green tone can vary in its brightness and its proportion of yellow. Accordingly the data processing system assigns the information “piece of luggage was checked-in in the Schengen area” to the piece of luggage 18.

It can further be stored as prior information in the data processing unit 6 that each element that has a barcode 34 is a luggage label. The form that the set of information 30 of a luggage label has and at which position of the luggage label which information of the set of information is to be found can further be stored as prior information in the data processing unit 6.

The piece of luggage 18 is sorted automatically using the visual features 20 detected and also using the part of the set of information 30 recognized. Accordingly the piece of luggage 18 will be conveyed on a corresponding luggage belt, transported with a corresponding luggage belt, transported to a corresponding loading zone, transported to a corresponding gate and/or conveyed on a corresponding luggage claim belt.

FIG. 6 shows a database 52, which represents an alternative to the database 8 shown in FIG. 1.

The database 52 shown in FIG. 6 is stored in a Cloud 54 (and accordingly not in the data processing unit from FIG. 1) The database 52 comprises the data record of the piece of luggage 18, which comprise the comparative description. Each airport 56 involved in the transport of the piece of luggage 18 can access the database 52. In particular the database 52 comprises a number of data records, including the above-mentioned data record, wherein each of the data records comprises a comparative description.

Although the invention has been illustrated and described in greater detail by the preferred exemplary embodiments, the invention is not restricted by the disclosed examples however and other variations can be derived herefrom by the person skilled in the art, without departing from the scope of protection of the invention.

### LIST OF REFERENCE CHARACTERS

2 Luggage description system
4 Detection device
6 Data processing unit
8 Database
10 Computer program
12 Data transfer connection
14 Luggage belt
16 Roller
18 Piece of luggage
20 Feature
22 Additional element
24 Feature
26 Logo of a piece of luggage
28 Brand name of a piece of luggage
30 Set of information, clear text
32 Patterning
34 Barcode
36 Luggage number
38 Owner name
40 Destination airport abbreviation
42 Flight number
44 Transit airport abbreviation
46 Flight number
48 Flight date
50 Date of issue
52 Database
54 Cloud
56 Airport

1-21 (canceled)

22. A method for generating a description of a piece of luggage, which comprises the steps of:
detecting the piece of luggage by a visual detection device and creating an image of the piece of luggage;
extracting visual features of the piece of luggage from the image of the piece of luggage; and
generating the description of the piece of luggage from the visual features of the piece of luggage extracted from the image.

23. The method according to claim 22, wherein the visual features of the piece of luggage include at least one of:
a dimension of the piece of luggage;
a shape of the piece of luggage;
a color of the piece of luggage;
a patterning of the piece of luggage;
a logo of the piece of luggage; and
a brand name of the piece of luggage.

24. The method according to claim 22, which further comprises generating the description of the piece of luggage in a form of a description vector and/or in a form of a descriptive text.

25. The method according to claim 22, wherein the visual detection device is a hand-held detection device.

26. The method according to claim 22, which further comprises:
detecting an additional element disposed on the piece of luggage by the visual detection device, by means of which an additional image is created; and
extracting further visual features of the additional element from the additional image and an additional description is created from the further visual features of the additional element extracted, which, together with the description of the piece of luggage, forms an expanded description of the piece of luggage.

27. The method according to claim 22, wherein the piece of luggage has an additional element with a set of information in a form of clear text and during the visual detection the set of information is at least partly visually detected and at least a part of the set of information is recognized by means of optical text recognition.

28. The method according to claim 27, which further comprises further processing the piece of luggage automatically using a recognized part of the set of information.

29. The method according to claim 22, which further comprises extracting the visual features using prior knowledge and/or using trainable systems.

30. The method according to claim 22, which further comprises storing the description of the piece of luggage created during a visual detection of the piece of luggage as a comparative description.

31. The method according to claim 30, wherein the piece of luggage is a piece of flight luggage and the comparative description is made available to further airports involved in a transport of the piece of luggage.

32. The method according to claim 30, which further comprises employing the method during a checking process, wherein a check is made as to whether the description of the piece of luggage matches the comparative description, which is stored in a database.

33. The method according to claim 30, which further comprises employing the method during a checking process which utilizes a database having a plurality of comparative descriptions and a check is made during the checking as to which of the comparative descriptions in the database has a closest match with the description of the piece of luggage.

34. The method according to claim 22, wherein the method is employed for identification of a piece of luggage.

35. The method according to claim 22, wherein the method is employed for an assignment, wherein the description of the piece of luggage is used to assign information to the piece of luggage.

36. The method according claim 30, which further comprises employing the method for creating the image of the piece of luggage, wherein the image of the piece of luggage is created from the description of the piece of luggage, wherein the image of the piece of luggage is a picture of the piece of luggage, a schematic representation of the piece of luggage, a 2D model of the piece of luggage and/or a 3D model of the piece of luggage.

37. The method according to claim 36, which further comprises employing the method for finding a missing piece of luggage.

38. The method according to claim 36, which further comprises comparing the image of the piece of luggage created from the description of the piece of luggage with a comparison image, which is created from the comparative description.

39. The method according to claim 22, which further comprises employing the method during checking of a piece of luggage, wherein a check is made as to whether an appearance of the piece of luggage has changed.

40. The method according to claim 22, which further comprises employing the method for a plurality of pieces of luggage, wherein the description of the piece of luggage is made for each of the pieces of luggage.

41. The method according to claim 40, which further comprises employing the method for a statistical evaluation of visual features of the pieces of luggage, in which at least some of the visual features of the pieces of luggage detected are statistically evaluated.

42. A luggage description system, comprising:
a visual detection device; and
a data processing unit programmed to perform a method for generating a description of a piece of luggage, which comprises the steps of:
detecting the piece of luggage by said visual detection device and creating an image of the piece of luggage;
extracting visual features of the piece of luggage from the image of the piece of luggage; and
generating the description of the piece of luggage from visual features of the piece of luggage extracted from the image.
